(19) United States
(12) Patent Application Publication
(10) Pub. No.: US 2016/0324074 A1
(43) Pub. Date: Nov. 10, 2016

(54) PLANT VARIETY RECOMMENDATION METHOD AND APPARATUS

(71) Applicant: Xiaomi Inc., Beijing (CN)

(72) Inventors: Ke WU, Beijing (CN); Xinyu LIU, Beijing (CN)

(21) Appl. No.: 15/144,959

(22) Filed: May 3, 2016

(30) Foreign Application Priority Data
May 4, 2015 (CN) 201510221874.4

(51) Int. Cl. A01G 9/02; G06F 3/041; A01G 1/00

(52) U.S. Cl. CPC A01G 9/02; A01G 1/001; G06F 3/0416; G06F 3/0414; H04W 4/005

(57) ABSTRACT

The present disclosure relates to a plant variety recommendation method and apparatus, to prolong life cycle of a plant. The method includes determining an environmental parameter of an environment where a flower pot is located. The method also includes recommending a plant variety matching with the environmental parameter for the flower pot.

### CROSS-REFERENCE TO RELATED APPLICATIONS

This application is based upon and claims priority to Chinese Patent Application No. 201510221874.4, filed on May 4, 2015, the entire contents of which are incorporated herein by reference.

### TECHNICAL FIELD

The present disclosure relates to the field of Internet technologies and, more particularly, to a plant variety recommendation method and apparatus.

### BACKGROUND

With the advancement of living quality, users are imposing higher and higher requirements on living environments. Cultivating flowers and plants in rooms not only beautifies the living environments, but also improves the air quality in the rooms. However, due to restriction of the cultivation conditions, the plants are generally cultivated in flower pots. The flower pots are subjected to different environments due to their different locations. For example, plants that are cultivated in balconies generally enjoy a relatively long light irradiation duration, whereas plants that are cultivated at corners of bedrooms are subjected to a relatively short light irradiation duration. Therefore, when the users fail to cultivate the plants according to their growth habits, those plants would gradually wither and die.

### SUMMARY

Embodiments of the present disclosure provide a plant variety recommendation method and apparatus, to prolong life cycle of a plant.

According to a first aspect of the present disclosure, a plant variety recommendation method is provided. The method includes determining an environmental parameter of an environment where a flower pot is located. The method also includes recommending a plant variety matching with the environmental parameter for the flower pot.

According to a second aspect of the present disclosure, an apparatus for recommending a plant variety is provided. The apparatus includes a processor and a memory for storing instructions executable by the processor. The processor is configured to execute the instructions to determine an environmental parameter of an environment where a flower pot is located. The processor is also configured to execute the instructions to recommend the plant variety matching with the environmental parameter for the flower pot.

According to a third aspect of the present disclosure, a non-transitory computer-readable storage medium is provided. The non-transitory computer-readable storage medium has stored therein instructions that, when executed by one or more processors of an apparatus, cause the apparatus to perform a method for recommending a plant variety. The method includes determining an environmental parameter of an environment where a flower pot is located. The method also includes recommending the plant variety matching with the environmental parameter for the flower pot.

The technical solutions provided by the embodiments of the present disclosure achieve the following beneficial effects. A plant variety matching with the environmental parameter of the environment where the flower pot is located is recommended for the flower pot, such that a user can cultivate a plant matching with the environmental parameter in the flower pot. Hence, the plant grows according to its growth habits. This enables the user to avoid frequently buying plants for the same flower pot, thereby reducing the user's economic cost in buying plants. In addition, since the cultivation of the plant complies with its growth habits, good growth of the plant improves the user's enthusiasm in cultivating flowers and plants.

It shall be appreciated that the above general description and the detailed description hereinafter are only illustrative and interpretative, but not for limiting the present disclosure.

### BRIEF DESCRIPTION OF THE DRAWINGS

The accompanying drawings herein, which are incorporated into and constitute a part of the specification, illustrate embodiments consistent with the present disclosure, and together with the specification, serve to explain the principles of the present disclosure.

FIG. 1A is a flowchart illustrating a plant variety recommendation method according to an exemplary embodiment of the present disclosure;

FIG. 1B is a diagram illustrating one application scenario of a plant variety recommendation method according to an exemplary embodiment of the present disclosure;

FIG. 1C is a diagram illustrating another application scenario of a plant variety recommendation method according to an exemplary embodiment of the present disclosure;

FIG. 2A is a flowchart illustrating a plant variety recommendation method according to an exemplary embodiment of the present disclosure;

FIG. 2B is a schematic diagram illustrating a temperature variation curve according to an exemplary embodiment of the present disclosure;

FIG. 3 is a flowchart illustrating a plant variety recommendation method according to an exemplary embodiment of the present disclosure;

FIG. 4 is a flowchart illustrating a plant variety recommendation method according to an exemplary embodiment of the present disclosure;

FIG. 5 is a block diagram illustrating a plant variety recommendation apparatus according to an exemplary embodiment of the present disclosure;

FIG. 6 is a block diagram illustrating another plant variety recommendation apparatus according to an exemplary embodiment of the present disclosure; and

FIG. 7 is a block diagram illustrating an apparatus for use in plant variety recommendation according to an exemplary embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

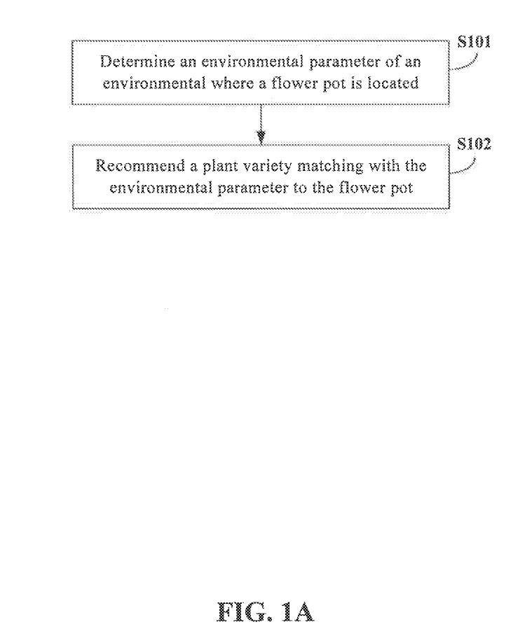

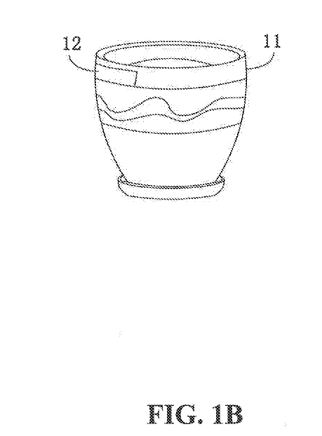

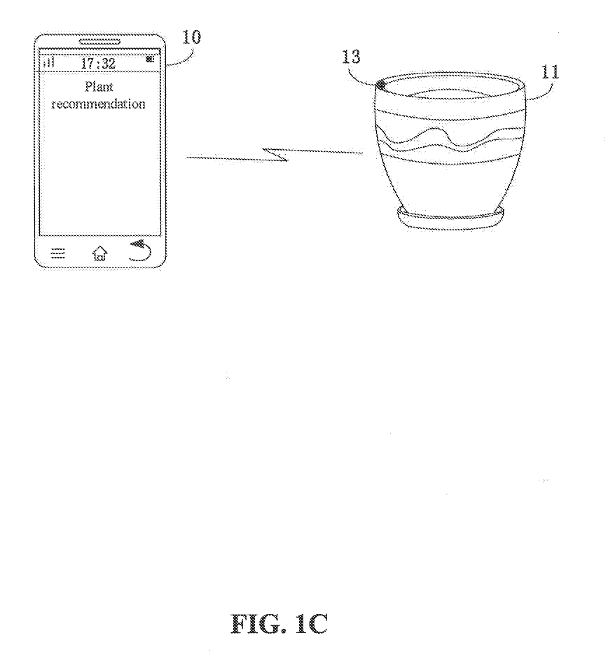

FIG. 1A is a flowchart illustrating a plant variety recommendation method according to an exemplary embodiment of the present disclosure. FIG. 1B is a diagram illustrating one application scenario of a plant variety recommendation method according to an exemplary embodiment of the present disclosure. FIG. 1C is a diagram illustrating another application scenario of a plant variety recommendation method according to an exemplary embodiment of the present disclosure. The plant variety recommendation method is applied in a terminal device, such as, for example, a smart phone, a tablet computer, or a desktop computer. In an embodiment, the plant variety recommendation method is implemented by an application installed in the terminal device. For example, the plant variety recommendation method can be implemented by software installed in a desktop computer. As illustrated in FIG. 1A, the plant variety recommendation method includes the following steps S101 and S102.

In step S101, an environmental parameter of an environment where a flower pot is located is determined.

In one embodiment, as illustrated in FIG. 1B, a flower pot 11 is provided with a terminal device 12. The terminal device 12 is configured to sense one or more environmental parameters of the environment where the flower pot 11 is located. In one embodiment, the environmental parameters sensed by the terminal device 12 include at least one of: a sunshine irradiation duration within a defined time period, a highest temperature value and a lowest temperature value within a defined time period, and a maximum humidity value and a minimum humidity value within a defined time period. In addition, the terminal device 12 further includes a display module (not shown in the drawings). The environmental parameters of the flower pot can be displayed on the display module, such that the user can see and read the environmental parameters of the environment where the flower pot is located.

In another embodiment, as illustrated in FIG. 1C, the flower pot 11 is provided with a sensor apparatus 13. The sensor apparatus 13 is communicatively connected to a smart device 10 to transmit sensed data to smart device 10. In one embodiment, the sensor apparatus 13 includes at least one of a light irradiation sensor, a temperature sensor, and a humidity sensor. The light irradiation sensor is configured to detect a sunshine irradiation duration of the flower pot within a defined time period (for example, within one day or within one year). The temperature sensor is configured to detect a temperature (measured data of which can be used for determining a temperature curve) of the flower pot within a defined time period. The humidity sensor is configured to detect a humidity (measured data of which can be used for determining a humidity curve) of the flower pot within a defined time period. The environmental parameter includes at least one of: a sunshine irradiation duration within a defined time period, a highest temperature value and a lowest temperature value within a defined time period, and a maximum humidity value and a minimum humidity value within a defined time period. For example, based on the sunshine irradiation duration, at least one of the following can be determined: the sunshine irradiation condition of the location of the flower pot, whether the sunshine is shaded by buildings, and the orientation of the flower pot. As a further example, the temperature and temperature difference of the location of the flower pot can be determined based on the highest temperature value and the lowest temperature value. For example, a flower pot at the top floor of a building is subjected to a greater temperature difference, whereas an indoor flower pot is subjected to a smaller temperature variation. A flower pot in a heated room is also subjected to a smaller temperature difference. The humidity and humidity variation of the location of the flower pot can be determined based on the maximum humidity value and the minimum humidity value.

In step S102, a plant variety matching with the environmental parameter is recommended for the flower pot.

In one embodiment, the plant variety matching with the environmental parameter is determined based on a plant database. For example, for flower pots placed at different locations, suitable plant varieties are determined according to their respective different environmental parameters and recommended for the flower pots. Since the environmental parameters are different, plant varieties more suitable for the environments where the flower pots are located are recommended for the flower pots according to the environmental parameters, such that the plants cultivated in the flower pots grow healthily. In one embodiment, the recommended plant variety is displayed on a display module of the terminal device 12. In another embodiment, the recommended plant variety is displayed on a display screen of the smart phone 10, as illustrated in FIG. 1C. Through display of the plant variety, the user can directly determine a plant variety matching with the environmental parameters associated with the flower pot. In one embodiment, data regarding the recommended plant variety is played using a voice playing module provided with the terminal device 12. In another embodiment, data regarding the recommended plant variety is played using a player of the smart phone 10.

In one embodiment, a plant variety matching with the environmental parameter of the environment where the flower pot is located is recommended for the flower pot, such that a user can cultivate a plant matching with the environmental parameter in the flower pot. The plant grows according to its growth habits. This enables the user to avoid frequently buying plants for the same flower pot, thereby reducing the user's economic cost in buying plants. In addition, since the cultivation of the plant complies with its growth habits, good growth of the plant improves the user's enthusiasm in cultivating flowers and plants.

In one embodiment, the method further includes determining a geographical location of the flower pot; determining a temperature variation curve corresponding to the geographical location; and recommending a plant variety matching with the temperature variation curve for the flower pot.

In one embodiment, recommending a plant variety matching with the environmental parameter for the flower pot includes searching for a plant variety matching with the environmental parameter in a plant database; and recommending the matched plant variety for the flower pot.

In one embodiment, the method further includes determining a cultivation pattern of the plant variety according to the environmental parameter.

In one embodiment, the method further includes determining a pollutant index of the environment where the flower pot is located; and recommending a plant variety matching with the pollutant index for the flower pot.

In one embodiment, the method further includes determining a ventilation index of the environment where the flower pot is located; and recommending a plant variety matching with the ventilation index for the flower pot.

In one embodiment, the method further includes determining a water quality parameter of the flower pot; and recommending a plant variety matching with the water quality parameter for the flower pot.

Details about recommending a plant variety for the flower pot are discussed below.

In summary, according to the methods provided by the embodiments of the present disclosure, a plant grows according to its growth habits. This enables the user to avoid frequently buying plants for the same flower pot, thereby reducing the user's economic cost in buying plants. In addition, since the cultivation of the plant complies with its growth habits, good growth of the plant improves the user's enthusiasm in cultivating flowers and plants.

Hereinafter, the technical solutions of the embodiments of the present disclosure are described with reference to specific embodiments.

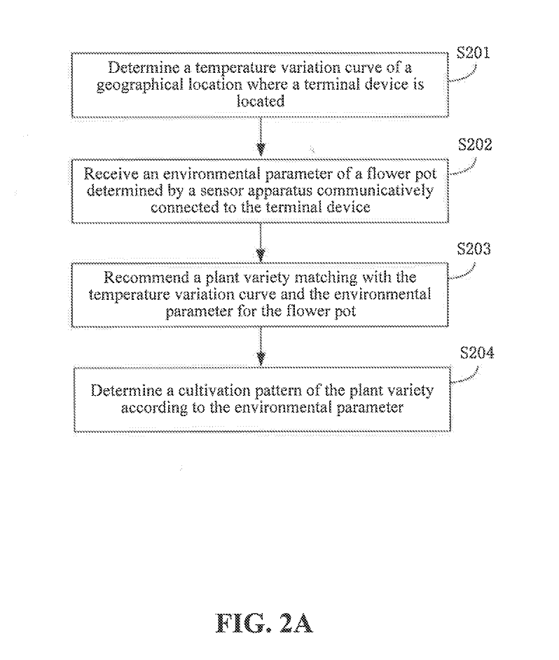

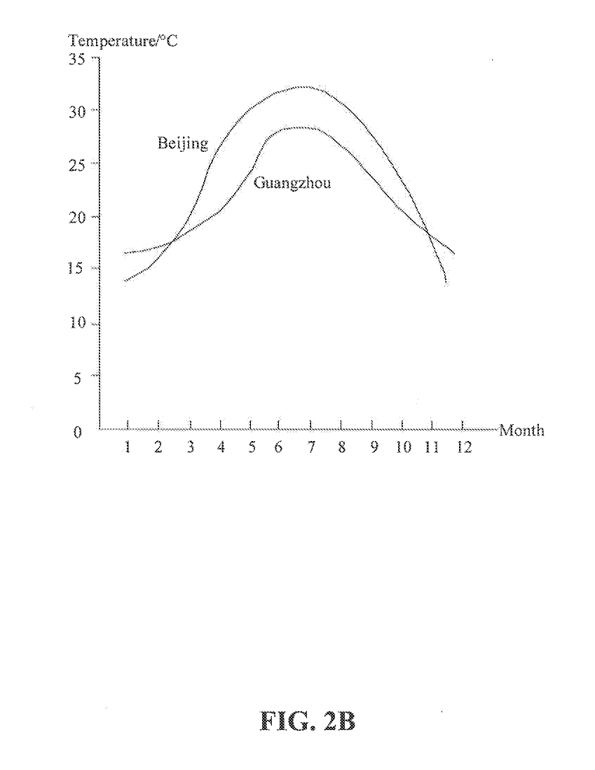

FIG. 2A is a flowchart illustrating a plant variety recommendation method according to an exemplary embodiment of the present disclosure. FIG. 2B is a schematic diagram illustrating a temperature variation curve according to an exemplary embodiment of the present disclosure. The disclosed method is described using the following as an example: recommendation of a plant variety matching with a temperature variation curve and an environmental parameter of a geographical location of a flower pot. As illustrated in FIG. 2A, the method includes the following steps.

In step S201, a temperature variation curve of a geographical location where a terminal device is located is determined.

In one embodiment, the geographical location of the terminal device is determined using a positioning module of the terminal device, and the temperature variation curve corresponding to the geographical location is determined. For example, after it is determined using the positioning module of the terminal device that the geographical location of the terminal device is Beijing, the temperature variation curve of Beijing within one year is acquired from a meteorological service platform, or the temperature variation curve for Beijing within one year is acquired from a meteorological application (app) of the terminal device. As illustrated in FIG. 2B, temperature variation curves of Guangzhou and Beijing within one year are obtained. As seen from the temperature variation curves, Guangzhou has experienced smaller temperature variations, whereas Beijing has experienced greater temperature variations. Therefore, plant varieties suitable for the above temperature variations can be determined according to the temperature variation curves.

In step S202, an environmental parameter of the flower pot determined by a sensor apparatus communicatively connected to the terminal device is received.

As illustrated in FIG. 1C, in one embodiment, the sensor apparatus 13 includes at least one of a light irradiation sensor, a temperature sensor, and a humidity sensor. The light irradiation sensor is configured to detect a sunshine irradiation duration of the flower pot (for example, within one day). The temperature sensor is configured to detect a temperature (measured data of which can be used for determining a temperature curve) of the flower pot (for example, within one day). The humidity sensor is configured to detect a humidity (measured data of which can be used for determining a humidity curve) of the flower pot (for example, within one day). Accordingly, the environmental parameter includes at least one of: a sunshine irradiation duration within one day, a highest temperature value and a lowest temperature value within, e.g., one day, and a maximum humidity value and a minimum humidity value within, e.g., one day. For example, based on the sunshine irradiation duration, at least one of the following can be determined: the sunshine irradiation condition of the location of the flower pot, whether the sunshine is shaded by buildings, and the orientation of the flower pot. In some embodiments, the temperature and temperature difference of the location of the flower pot can be determined according to the highest temperature value and the lowest temperature value. For example, a flower pot at the top floor of a building is subjected to a greater temperature difference, and an indoor flower pot is subjected to a smaller temperature variation. A flower pot in a heated room is also subjected to a smaller temperature difference. The humidity and humidity variation of the location of the flower pot can be determined according to the maximum humidity value and the minimum humidity value. For example, flower pots in different environments in Beijing are subjected to different humidity conditions.

In step S203, a plant variety matching with the temperature variation curve and the environmental parameter is recommended for the flower pot.

In an embodiment, the plant variety matching with the temperature variation curve and the environmental parameter can be determined based on a plant database. For example, for different flower pots placed in Beijing and Guangzhou, suitable plant varieties can be determined according to their respective different temperature variation curves and recommended for the flower pots. For different flower pots placed in Beijing, since their environmental parameters are different, plant varieties more suitable for the environments of the flower pots can be recommended for the respective flower pots according to the environmental parameters, such that the plants cultivated in the flower pots grow healthily.

In the disclosed embodiments, a plant variety matching with the temperature variation curve and the environmental parameter of the environment where the flower pot is located is recommended for the flower pot, such that a user can cultivate a plant matching with the temperature variation curve and the environmental parameter in the flower pot. The plant grows according to its growth habits. This enables the user to avoid frequently buying plants for the same flower pot, thereby reducing the user's economic cost in buying plants. In addition, since the cultivation of the plant complies with its growth habits, good growth of the plant improves the user's enthusiasm in cultivating flowers and plants.

In step S204, a cultivation pattern of the plant variety is determined according to the environmental parameter.

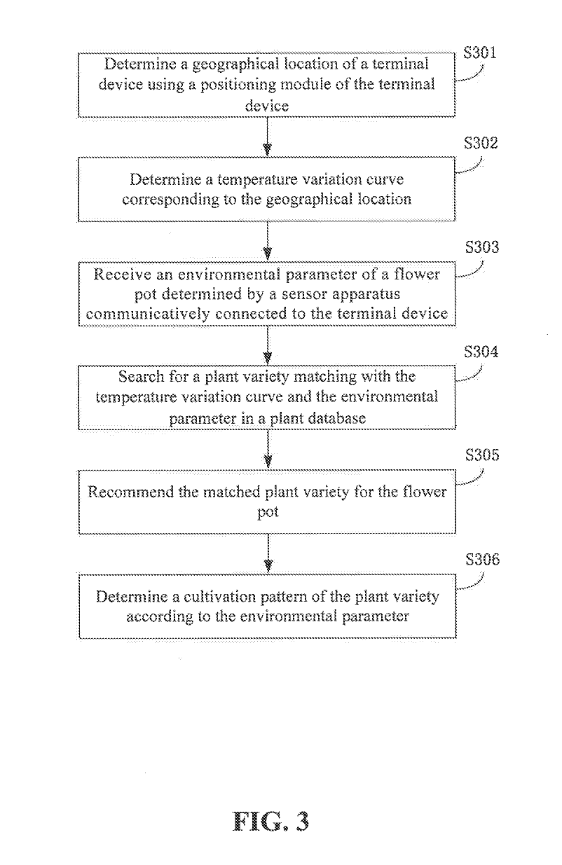

FIG. 3 is a flowchart illustrating a plant variety recommendation method according to an exemplary embodiment of the present disclosure. The disclosed method is illustrated using the following as an example: determination of a geographical location of a terminal device via a positioning module of the terminal device, and recommendation of a plant variety matching with an environmental parameter of the flower pot. As illustrated in FIG. 3, the method includes the following steps.

In step S301, a geographical location of a terminal device is determined using a positioning module of the terminal device.

In one embodiment, the positioning module of the terminal device is a GPS positioning module or a Beidou navigation positioning module. In another embodiment, when the terminal device is a smart phone, a geographic attribution associated with a mobile phone number of a user of the smart phone is determined by a WiFi hotspot positioning module of the smart phone, or based on base station information of the smart phone. In still another embodiment, positioning of the terminal device is implemented based on an IP address of the terminal device. The specific implementation of the positioning module is not limited in the present disclosure, as long as a position of the terminal device can be determined using a positioning module.

In step S302, a temperature variation curve corresponding to the geographical location is determined.

In one embodiment, the terminal device acquires the temperature variation curve corresponding to the geographical location from a meteorological service platform. Additionally or alternatively, the terminal device acquires the temperature variation curve corresponding to the geographical location from a server corresponding to a weather application (app) installed on the terminal device. The method of acquiring the temperature variation curve corresponding to a geographical location is not limited in the present disclosure.

In step S303, an environmental parameter of the flower pot determined by a sensor apparatus communicatively connected to the terminal device is received.

Description of step S303 is similar to the description of step S202, which is not repeated.

In step S304, a plant variety matching with the temperature variation curve and the environmental parameter is searched in a plant database.

In step S305, a matched plant variety is recommended for the flower pot.

In the above steps S304 and S305, in one embodiment, the plant database includes temperature conditions and ranges of environmental parameters suitable for cultivation of different plants. For example, for aloe, the plant database includes at least information reflecting one or more of the following: a growth-favorable environmental temperature is 20-30° C., a night optimal temperature is 14-17° C., aloe almost stops growing at a temperature below 10° C., aloe mesophyll would wither and die at a temperature below 0° C., an optimal light irradiation duration is 5-7 hours, and an optimal humidity (for illustrative purposes, relative humidity is used in the present disclosure as an example) is 30%-60%. When it is determined that the temperature variation curve and the environmental parameter match with aloe, related cultivation information of aloe is searched from the plant database.

In step S306, a cultivation pattern of the plant variety is determined according to the environmental parameter.

In one embodiment, the cultivation pattern includes cuttage, leaf cutting, seedling cultivation, water culture, soil culture, and the like. For example, for aloe, a user is recommended to directly buy young aloe and employ the soil culture pattern.

In the above embodiments, a cultivation pattern of a plant variety is determined according to the environmental parameter, such that the user cultivates the plant according to the growth environment that better matches with the recommended plant variety. In this way, because the cultivation of the plant complies with its growth habits, good growth of the plant is ensured. As a result, the user's enthusiasm in cultivating flowers and plants is improved while the living environment is beautified.

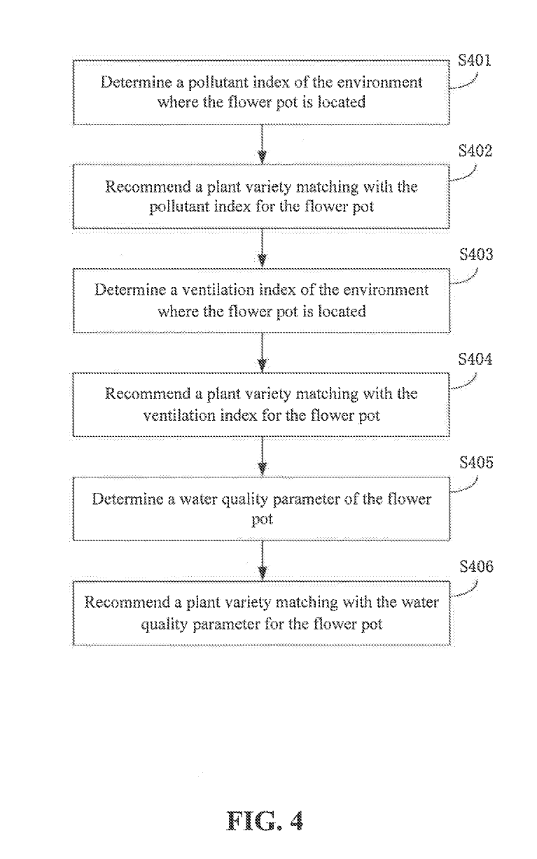

FIG. 4 is a flowchart illustrating a plant variety recommendation method according to an exemplary embodiment of the present disclosure. In this embodiment, the disclosed method is illustrated using the following as an example: recommendation of a plant variety based on a pollutant index, a ventilation index, or a water quality parameter. As illustrated in FIG. 4, the method includes the following steps.

In step S401, a pollutant index of the environment where the flower pot is located is determined.

In one embodiment, the pollutant index of the environment where the flower pot is located is acquired by using a smart air purifier, wherein the pollutant index includes at least one of the following: contents of formaldehyde, benzene series, ammonia and the like substance, and a PM2.5 indicator.

In step S402, a plant variety matching with the pollutant index is recommended for the flower pot.

For example, when the content of formaldehyde in the environment where the flower pot is located reaches a first threshold, the plant variety matching with the formaldehyde indicator can be recommended. For example, green plants that are highly resistant against formaldehyde, including chlorophytum comosum, aglaonema, hamiltoniana cv.mustrata marginata, ivy stem, aloe, agave, and epipremnum aureum, can be recommended.

In step S403, a ventilation index of the environment where the flower pot is located is determined.

In one embodiment, the ventilation index of the environment where the flower pot is located is detected using a sensor disposed at a window of a room. The ventilation index includes a ventilation quantity flowing into the room and a ventilation quantity flowing out of the room within one day. Based on these ventilation quantities, the ventilation index of the environment where the flower pot is located is determined.

In step S404, a plant variety matching with the ventilation index is recommended for the flower pot.

For example, based on the plant varieties recommended according to the above pollutant index, a plant variety matching with the ventilation index is screened out from the recommended plant varieties, such that information regarding the recommended plant variety is more accurate. For example, among the chlorophytum comosum, aglaonema, hamiltoniana cv.mustrata marginata, ivy stem, aloe, agave, and epipremnum aureum, in a room with a low ventilation index, such green plants as aglaonema and hamiltoniana cv.mustrata marginata that impose not very high requirement on ventilation can be recommended. In a room with a high ventilation index, such green plants as chlorophytum comosum, agave, ivy stem, aloe and epipremnum aureum that impose high requirement on ventilation can be recommended.

In step S405, a water quality parameter of the flower pot is determined.

In one embodiment, the water quality parameter of the flower pot is measured using a water quality monitoring instrument.

In step S406, a plant variety matching with the water quality parameter is recommended for the flower pot.

For example, based on the plant varieties recommended according to the above pollutant index and the ventilation index, a plant variety matching with the water quality parameter is screened out from the recommended plant varieties, such that information regarding the recommended plant variety is more accurate. For example, among the chlorophytum comosum, ivy stem, aloe, agave, and epipremnum aureum, when it is determined that the water quality parameter of the flower pot indicates acid water, such acidophilous green plants as chlorophytum comosum, aloe, ivy stem, and agave are recommended. When it is determined that the water quality parameter of the flower pot indicates basic water, such basophilous green plants as epipremnum aureum are recommended. A person skilled in the art would understand that the above green plants are only for illustration purposes, and are not for limiting the scope of the present disclosure.

In the above embodiments, by recommending a plant variety matching with at least one of the pollutant index, the ventilation index, and the water quality parameter for the flower pot, the accuracy in recommending the plant variety is improved. In this way, good growth of the plant during the entire cultivation process is ensured, and the user's enthusiasm in cultivating flowers and plants is improved while the living environment is beautified.

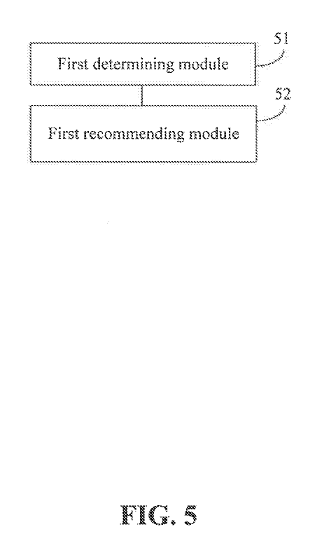

FIG. 5 is a block diagram illustrating a plant variety recommendation apparatus according to an exemplary embodiment of the present disclosure. As illustrated in FIG. 5, the plant variety recommendation apparatus includes a first determining module 51 configured to determine an environmental parameter of a flower pot. The plant variety recommendation apparatus also includes a first recommending module 52 configured to recommend, for the flower pot, a plant variety matching with the environmental parameter determined by the first determining module 51.

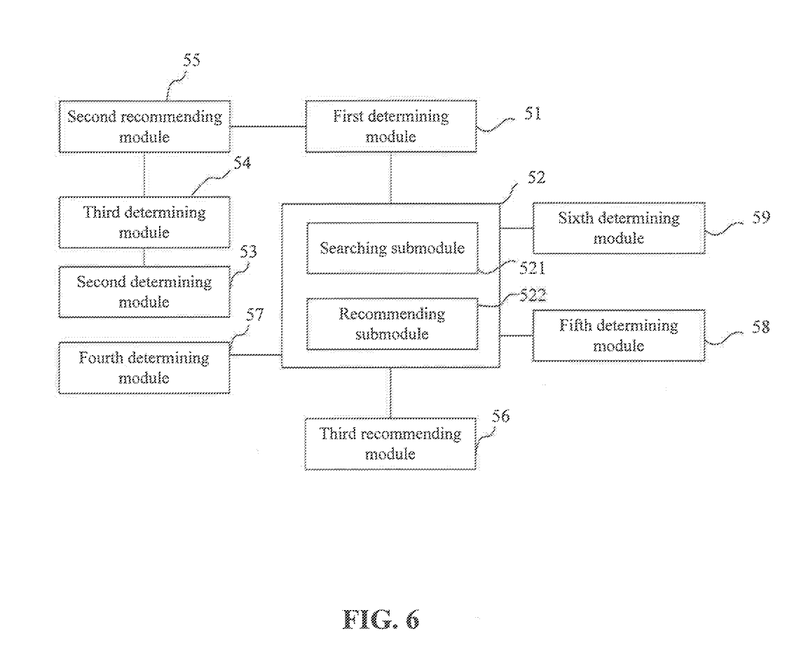

FIG. 6 is a block diagram illustrating another plant variety recommendation apparatus according to an exemplary embodiment of the present disclosure. The embodiment shown in FIG. 6 is based on the embodiment illustrated in FIG. 5, and includes additional elements. For example, the apparatus further includes a second determining module 53 configured to determine a geographical location of the flower pot. The apparatus also includes a third determining module 54 configured to determine a temperature variation curve corresponding to the geographical location determined by the second determining module 53. The apparatus further includes a second recommending module 55 configured to recommend, for the flower pot, a plant variety matching with the temperature variation curve determined by the third determining module 54 and the environment parameter determined by the first determining module 51.

In one embodiment, the first recommending module 52 includes a searching submodule 521 configured to search for a plant variety matching with the environmental parameter determined by the first determining module 51 from a plant database, and a recommending submodule 522 configured to recommend the matched plant variety searched by the searching submodule 521 for the flower pot.

In one embodiment, the apparatus further includes a third recommending module 56 configured to determine a cultivation pattern of the plant variety according to the environmental parameter determined by the first determining module 51.

In one embodiment, the apparatus further includes a fourth determining module 57 configured to determine a pollutant index of the environment where the flower pot is located. The first recommending module 52 is configured to recommend a plant variety matching with the pollutant index determined by the fourth determining module 57 for the flower pot.

In one embodiment, the apparatus further includes a fifth determining module 58 configured to determine a ventilation index of the environment where the flower pot is located. The first recommending module 52 is configured to recommend, for the flower pot, a plant variety matching with the ventilation index determined by the fifth determining module 58.

In one embodiment, the apparatus further includes a sixth determining module 59 configured to determine a water quality parameter of the flower pot. The first recommending module 52 is configured to recommend, for the flower pot, a plant variety matching with the water quality parameter determined by the sixth determining module 59.

With respect to the apparatuses in the above embodiments, the specific implementations of operations executed by various modules thereof have been described in detail in the discussion of the embodiments of the methods. Therefore, the detailed descriptions of the operations are not repeated.

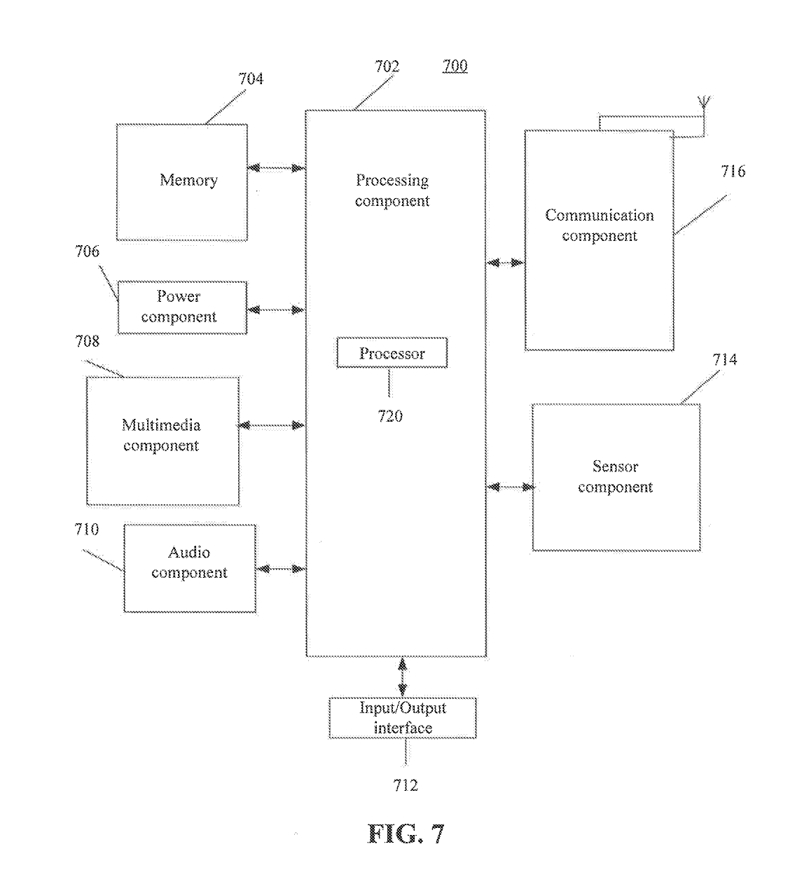

FIG. 7 is a block diagram illustrating an apparatus for use in plant variety recommendation according to an exemplary embodiment of the present disclosure. For example, the apparatus 700 can be a mobile phone, a computer, a digital broadcast terminal, a messaging device, a gaming console, a tablet, a medical device, exercise equipment, a personal digital assistant, and the like.

Referring to FIG. 7, the apparatus 700 includes one or more of the following components: a processing component 702, a memory 704, a power component 706, a multimedia component 708, an audio component 710, an input/output (I/O) interface 712, a sensor component 714, and a communication component 716.

The processing component 702 is configured to control overall operations of the apparatus 700, such as the operations associated with display, telephone calls, and data communications, camera operations, and recording operations. The processing component 702 includes one or more processors 720 configured to execute instructions to perform all or part of the above-described methods. In addition, the processing component 702 includes one or more modules configured to facilitate the interaction between the processing component 702 and other components. For example, the processing component 702 includes a multimedia module configured to facilitate the interaction between the multimedia component 708 and the processing component 702.

The memory 704 is configured to store various types of data to support the operations of the apparatus 700. Examples of such data include instructions for any application or method operated on the apparatus 700, contact data, phonebook data, messages, pictures, videos, and the like. The memory 704 can be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 706 is configured to provide power to various components of the apparatus 700. The power component 706 includes a power management system, one or more power supplies, and other components associated with the generation, management, and distribution of power in the apparatus 700.

The multimedia component 708 includes a screen providing an output interface between the apparatus 700 and the user. In some embodiments, the screen includes a liquid crystal display and a touch panel. If the screen includes the touch panel, the screen can be implemented as a touch screen to receive input signals from the user. The touch panel includes one or more touch sensors configured to sense touches, swipes, and gestures on the touch panel. The touch sensors not only sense a boundary of a touch or swipe action, but also sense a period of time and a pressure associated with the touch or swipe action. In some embodiments, the multimedia component 708 includes a front camera and/or a rear camera. The front camera and/or the rear camera are configured to receive external multimedia data while the apparatus 700 is in an operation mode, such as a photographing mode or a video mode. Each of the front camera and the rear camera can be a fixed optical lens system or can have focus and optical zoom capability.

The audio component 710 is configured to output audio signals and/or receive an input of audio signals. For example, the audio component 710 includes a microphone configured to receive an external audio signal when the apparatus 700 is in an operation mode, such as a call mode, a recording mode, or a voice recognition mode. The received audio signal can be further stored in the memory 704 or transmitted via the communication component 716. In some embodiments, the audio component 710 further includes a speaker configured to output audio signals.

The I/O interface 712 is configured to provide an interface between the processing component 702 and a peripheral interface module, such as a keyboard, a click wheel, a button, or the like. The buttons include, but are not limited to, a home button, a volume button, a starting button, and a locking button.

The sensor component 714 includes one or more sensors configured to provide status assessments of various aspects of the apparatus 700. For example, the sensor component 714 can detect an open/closed status of the apparatus 700, relative positioning of components, e.g., the display and the keypad, of the apparatus 700, a change in position of the sensor component 714 or a component of the apparatus 700, a presence or absence of user contact with the apparatus 700, an orientation or an acceleration/deceleration of the apparatus 700, and a change in temperature of the apparatus 700. The sensor component 714 includes a proximity sensor configured to detect the presence of nearby objects without any physical contact. The sensor component 714 also includes a light sensor, such as a CMOS or CCD image sensor, for use in imaging applications. In some embodiments, the sensor component 714 also includes an accelerometer sensor, a gyroscope sensor, a magnetic sensor, a pressure sensor, or a temperature sensor.

The communication component 716 is configured to facilitate wired or wireless communications between the apparatus 700 and other devices. The apparatus 700 can access a wireless network based on a communication standard, such as WiFi, 2G, 3G, 4G, or a combination thereof. In one example embodiment, the communication component 716 receives a broadcast signal or broadcast associated information from an external broadcast management system via a broadcast channel. In one example embodiment, the communication component 716 further includes a near field communication (NFC) module configured to facilitate short-range communications. For example, the NFC module can be implemented based on a radio frequency identification (RFID) technology, an infrared data association (IrDA) technology, an ultra-wideband (UWB) technology, a Bluetooth (BT) technology, and other technologies.

In example embodiments, the apparatus 700 can be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above-described methods.

In some embodiments, there is also provided a non-transitory computer-readable storage medium including instructions, such as included in the memory 704, executable by the processor 720 in the apparatus 700, for performing the above-described methods. For example, the non-transitory computer-readable storage medium can be a ROM, a random access memory (RAM), a compact disc read-only memory (CD-ROM), a magnetic tape, a floppy disc, an optical data storage device, or the like.

Other embodiments of the present disclosure will be apparent to those skilled in the art from consideration of the specification and practice disclosed herein. This application is intended to cover any variations, uses, or adaptations of the present disclosure following the general principles thereof and including such departures from the present disclosure as coming within common knowledge or customary technical means in the art. It is intended that the specification and embodiments be considered as exemplary only, with a true scope and spirit of the present disclosure being indicated by the appended claims.

It will be appreciated that the present disclosure is not limited to the exact construction that has been described above and illustrated in the accompanying drawings, and that various modifications and changes can be made without departing from the scope thereof. The scope of the present disclosure is only defined by the appended claims.

What is claims is:

1. A plant variety recommendation method, comprising:
determining an environmental parameter of an environment where a flower pot is located; and
recommending a plant variety matching with the environmental parameter for the flower pot.

2. The method according to claim 1, further comprising:
determining a geographical location of the flower pot;
determining a temperature variation curve corresponding to the geographical location, the environmental parameter including the temperature variation curve; and
recommending the plant variety matching with the temperature variation curve for the flower pot.

3. The method according to claim 1, wherein recommending the plant variety matching with the environmental parameter for the flower pot comprises:
searching for the plant variety matching with the environmental parameter from a plant database; and
recommending the matched plant variety for the flower pot.

4. The method according to claim 1, further comprising:
determining a cultivation pattern of the plant variety according to the environmental parameter.

5. The method according to claim 1, further comprising:
determining a pollutant index of the environment where the flower pot is located, the environmental parameter including the pollutant index; and
recommending the plant variety matching with the pollutant index for the flower pot.

6. The method according to claim 1, further comprising:
determining a ventilation index of the environment where the flower pot is located, the environmental parameter including the ventilation index; and
recommending the plant variety matching with the ventilation index for the flower pot.

7. The method according to claim 1, further comprising
determining a water quality parameter of the flower pot, the environmental parameter including the water quality parameter; and
recommending the plant variety matching with the water quality parameter for the flower pot.

8. An apparatus for recommending a plant variety, comprising:
a processor; and
a memory for storing instructions executable by the processor,
wherein the processor is configured to execute the instructions to:
determine an environmental parameter of an environment where a flower pot is located; and
recommend the plant variety matching with the environmental parameter for the flower pot.

9. The apparatus according to claim 8, wherein the processor is further configured to:
determine a geographical location of the flower pot;
determine a temperature variation curve corresponding to the geographical location, the environmental parameter including the temperature variation curve; and
recommend the plant variety matching with the temperature variation curve for the flower pot.

10. The apparatus according to claim 8, wherein the processor is further configured to:
search for a plant variety matching with the environmental parameter from a plant database; and
recommend the matched plant variety for the flower pot.

11. The apparatus according to claim 8, wherein the processor is further configured to:
determine a cultivation pattern of the plant variety according to the environmental parameter.

12. The apparatus according to claim 8, wherein the processor is further configured to:
determine a pollutant index of the environment where the flower pot is located, the environmental parameter including the pollutant index; and
recommend the plant variety matching with the pollutant index for the flower pot.

13. The apparatus according to claim 8, wherein the processor is further configured to:
determine a ventilation index of the environment where the flower pot is located, the environmental parameter including the ventilation index; and
recommend the plant variety matching with the ventilation index for the flower pot.

14. The apparatus according to claim 8, wherein the processor is further configured to:
determine a water quality parameter of the flower pot, the environmental parameter including the water quality; and
recommend the plant variety matching with the water quality parameter for the flower pot.

15. A non-transitory computer-readable storage medium having stored therein instructions that, when executed by one or more processors of an apparatus, cause the apparatus to perform a method for recommending a plant variety, the method comprising:
determining an environmental parameter of an environment where a flower pot is located; and
recommending the plant variety matching with the environmental parameter for the flower pot.
